(19) United States
(12) Patent Application Publication
(10) Pub. No.: US 2016/0180164 A1
(43) Pub. Date: Jun. 23, 2016

(54) METHOD FOR CONVERTING PAPER FILE INTO ELECTRONIC FILE

(71) Applicant: BEIJING BRANCH OFFICE OF FOXIT CORPORATION, Beijing (CN)

(72) Inventors: Yuqian Xiong, Beijing (CN); Meiling Zhou, Beijing (CN)

(21) Appl. No.: 14/910,011

(22) PCT Filed: Jul. 22, 2014
(86) PCT No.: PCT/CN2014/000694

§ 371 Date: Feb. 4, 2016

(30) Foreign Application Priority Data
Aug. 12, 2013 (CN) 201310349738.4

(51) Int. Cl. G06K 9/00; G06F 17/21; G06K 9/34

(52) U.S. Cl. CPC G06K 9/00463; G06K 9/00456; G06K 9/34; G06F 17/211

(57) ABSTRACT

A method for converting a paper file into an electronic file. The method comprises: step 1: scanning a paper file into an electronic picture file; step 2: segmenting a non-blank part contained in the electronic picture file into blocks, so that the non-blank part is segmented into several blocks, wherein a block is one of a row or a column; step 3: segmenting each block into more than one character picture; step 4: determining a position relationship between the blocks and a position relationship between character pictures belonging to the same block; step 5: arranging all character pictures belonging to the same block into a new block according to the position relationship therebetween; and step 6: arranging all the new blocks according to the position relationship between the blocks to obtain an electronic file.

### FIELD OF THE INVENTION

The present invention relates to the technical field of converting paper files into electronic files, and more particularly to method for converting a paper file into an electronic file.

### BACKGROUND OF THE INVENTION

The emergence of tablet computers, electronic books and other similar technologies makes reading objects gradually changed from paper files to electronic files. Readers need a technology for converting the existing numerous paper files into electronic files.

A common technology for converting paper files into electronic files is an OCR (Optical Character Recognition) technology. Its specific process comprises: scanning a paper file to obtain an electronic image file; segmenting the electronic image file into multiple character images, wherein each character image only includes one character; recognizing the character of each character image one by one, wherein an error correction function and an association function are included to reduce an error rate; sequentially outputting character recognition results, thereby obtaining a final electronic file.

The core of the OCR technology is one-by-one recognition of character images, and its judgment is based on the outline of each character image. However, too many characters have similar outlines, so that the recognition accuracy is low, and the accuracy of the finally obtained electronic file is also low. To improve the recognition accuracy, the OCR technology spends a lot of time to perform character recognition, search on suspicious character, error correction and the like, so that the efficiency of the OCR technology is also low.

### SUMMARY OF THE INVENTION

A technical problem solved by the present invention is to provide a method for converting a paper file into an electronic file, and then the method can simultaneously improve the conversion efficiency and the content matching degree of the electronic file and the paper file.

The technical solution to solve the above technical problem of the present invention is as follows: a method for converting a paper file into an electronic file, wherein the method comprises:

Step 1: scanning a paper file to obtain an electronic image file;

Step 2: segmenting a non-blank part contained in the electronic image file into blocks, so that the non-blank part is segmented into a plurality of blocks; wherein a block is one of a row and a column;

Step 3: segmenting each block into at least one character image;

Step 4: determining a position relationship between the blocks and a position relationship between the character images belonging to the same block;

Step 5: arranging all character images belonging to the same block into a new block according to the position relationship therebetween;

Step 6: arranging all the new blocks according to the position relationship between the blocks, thereby obtaining an electronic file.

The present invention has the beneficial effects:in the present invention, a paper file is scanned to obtain an electronic image file; a non-blank part of the electronic image file is segmented into blocks, thereby obtaining a plurality of blocks; the blocks are segmented into character images; the character images are rearranged to form new blocks according to the position relationship between the character images; the obtained new blocks are arranged to form an electronic file according to the position relationship between the blocks. Therefore, the present invention does not need to perform the processing of character recognition, search on suspicious characters, error correction, association and the like in the existing OCR technology, and only needs to utilize the character images obtained by segmenting the electronic image file to complete a conversion task, thereby greatly improving the conversion efficiency. Simultaneously, the present invention rearranges the character images obtained by segmenting the electronic image file to obtain the electronic file, so that the recognition error is avoided, the content matching degree of the electronic file and the paper file is largely improved, and the character accuracy basically can be up to 100%.

On the basis of the technical solution, the present invention may also be made the following improvements:

Further, after the step 1 and before the step 2, the method further comprises a step 1-2: rotating the electronic image file to enable characters of the electronic image file in a straight direction;

Further, before rotating the electronic image file, the step 1-2 further comprises: removing stains and scratches on the electronic image file;

Further, before removing the stains and the scratches of the electronic image file, the step 1-2 further comprises: enlarging the electronic image file;

Further, after rotating the electronic image file to enable characters of the electronic image file in a straight direction, the step 1-2 further comprises cutting off white edge parts in ranges of a top margin, a bottom margin, a left margin and a right margin of the electronic image file.

### BRIEF DESCRIPTION OF DRAWINGS

FIG. 1 is a flowchart of a method for converting a paper file into an electronic file, provided by the present invention;

FIG. 2 is a schematic diagram of an electronic image file obtained by scanning a paper file, provided by the present invention;

FIG. 3 is a schematic diagram of an electronic image file after rotating by utilizing the present invention;

FIG. 4 is a schematic diagram of an electronic image file after white edge parts in ranges of four margins are cut off by utilizing the present invention;

FIG. 5 is a schematic diagram of an electronic image file after a non-blank part contained in the electronic image file is segmented in row by utilizing the present invention; and

FIG. 6 is a schematic diagram of an electronic image file after blocks are segmented into character images by utilizing the present invention.

### DETAILED DESCRIPTION OF THE EMBODIMENTS

With reference to the accompanying drawings, the description of the principles and features of the present invention are given as following. The given examples are only applied to explaining the present invention, but not be applied to limit the scope of the present invention.

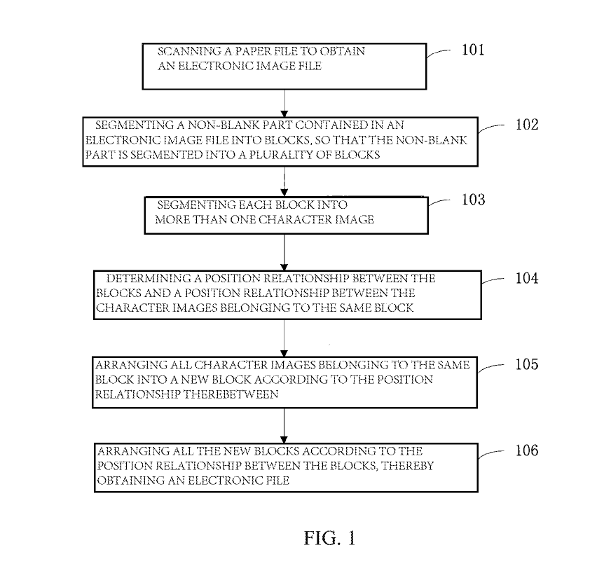

The present invention provides a method for converting a paper file into an electronic file. FIG. 1 is a flow chart of a method for converting a paper file into an electronic file. As shown in FIG. 1, the method comprises:

Step 101: scanning a paper file to obtain an electronic image file.

The paper file of the present invention can be any file recorded on the sheets or papers such as a book or an album.

The step of scanning a paper file to obtain an electronic image file is the first step for achieving paper file electronization, which can be performed by a scanner.

step 102: segmenting a non-blank part contained in the electronic image file, so that the non-blank part is segmented into a plurality of blocks.

The blocks provided by the present invention are one of a row or a column.

The electronic image file is obtained by the scanning step of the step 101. The content, such as characters, images, tables and the like, must be reflected in the electronic image file in a certain form (such as an image form and the like), which corresponds to the non-blank part of the electronic image file. Besides the above non-blank part, the electronic image file must contain blank parts, such as white edge parts in ranges of a top margin, a bottom margin, a left margin and a right margin, and the like.

The step 101 merely segments the non-blank part of the electronic image file, and a segmentation result is a plurality of blocks. Certainly, the segmentation result also is in an electronic image form. For example, if the non-blank part is segmented in row, the segmentation result is a plurality of rows in the electronic image form. Further, if the content of the non-blank part is a text, the segmentation result of this step is an electronic image of each row of the text. If the content of the non-blank part is a table, in a segmentation process, it is judged that the table is a table with a border or a table without the border; if the table is the table with the border, the table is taken as a row to be processed, that is the segmentation result is an electronic image of the table; if the table is the table without the border, the content of the table is segmented into blocks in row, that is, the segmetnation result is an electronic image of each row of the table. It should be noted that the segmentation result of a portion, the content of which is an image, of the electronic image file in this step still is an electronic image of the image, that is, if the content of the non-blank part is an image, the segmentation result still is an electronic image of the image. A method for segmentating the non-blank part in column is similar to the above method. If the content of the non-blank part is a text, the segmentation result of this step is an electronic image of each column of the text. If the content of the non-blank part is a table, it also should be judged that the table is a table with a border or a table without the border; if the table is the table with the border, the table is taken as a column to be processed, that is the segmentation result is an electronic image of the table; if the table is the table without the border, the content of the table is segmented into blocks in column, that is, the segmetnation result is an electronic image of each column of the table; if the content of the non-blank part is an image, the segmentation result still is an electronic image of the image, which is same as the segmentation result in row. The reason for judging whether the table is a table with the border or a table without a border in a table segmetnation process is: the line of the border connects the table into a whole body, and the table is not segmented into smaller rows or columns, so that the table only can be taken as a whole body (namely a row or a column) to be processed.

The blank part of the electronic image file does not correspond to the content of the paper file, so that the blank part does not need to be processed in this step.

Step 103: segmenting each block into at least one character image.

The blocks obtained in the step 102 merely come from initial segmentation on the non-blank part of the electronic image file. Actually, the amount (namely the content corresponding to the content of the paper file) of information of each block still is large, and the amount of the contained blank parts is also large, so that each block is further segmented in this step, and the segmentation result is called as character images. Each block is segmented into at least one character images, so that in most cases, the amount of information contained in each character image is smaller than that of a block, which the character image belongs to. Of course, it does not exclude that one block is segmented into one character image or all amount of information of one block is segmented into one character image, and the rest character images all do not include the amount of information. In the two cases, the amount of information of a certain character image is same as that of the block, which the character image bleongs to.

The character images in this step still are in the electronic image form, and its included information does not change.

Step 104: determining a position relationship between the blocks and a position relationship between the character images belonging to the same block.

This step is to determine the layout of the non-blank part of the electronic image file. A sequence between rows or columns can be determined by determining the position relationship between the blocks, and a sequence between each two adjacent character images in the same row can be determinined by determining the position relationship between the character images belonging to the same block.

Step 105: arranging all character images belonging to the same block into a new block according to the position relationship therebetween.

This step is to rearrange each character image to obtain a new block, and the arrangement rule is the position relationship between the character images belonging to the same block, which is determined in the step 104. Therefore, the content of the obtained new block is same as the content of the block, which the corresponding character images belong to. Furthermore, the arrangement does not involve in character recognition, so that character misreading does not occur, and as long as the arrangement sequence of the character images is right, the character accuracy of each new block can be completely up to 100%.

Each character image of each new block comes from a certain block obtained in the step 102, so that the new blocks and the blocks herein have one-to-one correspondence relationship actually.

Step 106: arranging all the new blocks according to the position relationship between the blocks, thereby obtaining an electronic file.

This step is to rearrange the new blocks obtained in the step 105, and the arrangement rule is the position relationship between the blocks, which is determined in the step 104. That is, this step is to arrange the new blocks according to the sequence of the corresponding blocks in the electronic image file, thereby obtaining an electronic file, the layout of which is consistent with the layout of the electronic image file and the layout of the paper file.

Therefore, in this present invention, a paper file is scanned to obtain an electronic image file; a non-blank part of the electronic image file is segmented into blocks, thereby obtaining a plurality of blocks; the blocks are segmented into character images; the character images are rearranged to form new blocks according to the position relationship between the character images; the obtained new blocks are arranged to form an electronic file according to the position relationship between the blocks. Therefore, the present invention does not need to perform the processing of character recognition, search on suspicious characters, error correction, association and the like in the existing OCR technology, and only needs to utilize the character images obtained by segmenting the electronic image file to complete a conversion task, thereby greatly improving the conversion efficiency. Simultaneously, the present invention rearranges the character images obtained by segmenting the electronic image file to obtain the electronic file, so that the recognition error is avoided, the content matching degree of the electronic file and the paper file is largely improved, and the character accuracy basically can be up to 100%.

After the step 101 and before the step 102, the method can further comprise a step 101-102: rotating the electronic image file to enable characters of the electronic image file in a straight direction.

The meanings of characters in a straight direction in the step 101-102 is as follows:if the electronic image file where the characters are located is displayed on a screen, an angle of each character displayed on the screen is totally consistent with its standard angle. For example, the standard angle of a numeral 1 is parallel to the left and right sides of the screen or a paper surface, and however, in the scanning step of the step 101, the obtained electronic image file generates rotation in a certain angle generally due to non-standard arrangement position of the paper file, so that the the numeral 1 displayed on the electronic image file is not arranged in its standard angle, but generates a certain included angle with the left and right sides of the electronic image file (or the screen). Therefore, before the step 102 is performed, the electronic image file needs to rotate to enable the characters on the electronic image file in the straight direction, and then the segmentation accurancy of the step 102 and the step 103 are improved.

Before rotating the electronic image file, the step 101-102 further comprises: removing stains and scratches on the electronic image file.

By adopting this step, the influence of noise data, such as the stains, the scratches and the like, on the conversion accuracy in the present invention can be reduced, the conversion time can be saved, and the conversion efficiency is improved.

Further, before removing stains and scratches on the electronic image file, the step 101-102 can comprise: enlarging the electronic image file.

The step of enlarging the electronic image file facilitates reduction on stain and scratch judgment difficulty and improvement on judgment accuracy.

Furthermore, after rotating the electronic image file to enable the characters of the electronic image file in the straight direction, the step 101-102 can comprise: cutting off white edge parts of the electronic image file in ranges of a top margin, a bottom margin, a left margin and a right margin.

By adopting the step of cutting off white edge parts of the electronic image file in ranges of the top margin, the bottom margin, the left margin and the right margin, a page range of the electronic image file can be reduced, the workload of follow-up steps is reduced, and the conversion efficiency and the accuracy are improved.

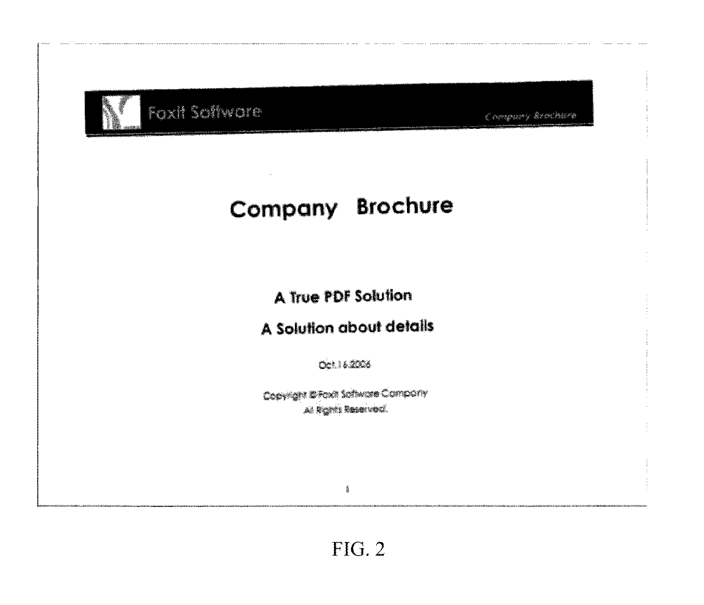

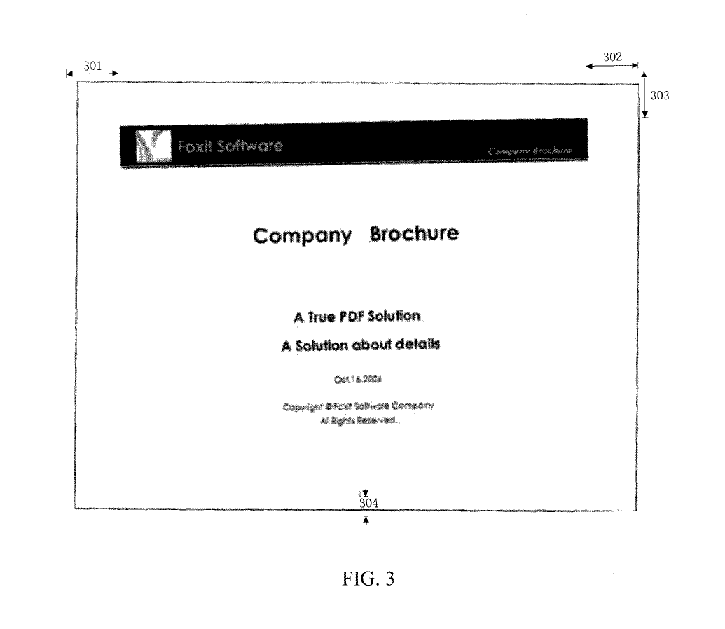

FIG. 2 is a schematic diagram of an electronic image file obtained by scanning a paper file, provided by the present invention. Intuitively, compared with the content of the paper file before scanning, the content displayed on the FIG. 2 generates rotation in a certain angle in a clockwise direction. Four black lines on the top, bottom, left side and right side represent the boundary of the electronic image file and do not make any sense, and the meanings of each black line on the FIG. 3-FIG. 6 is the same.

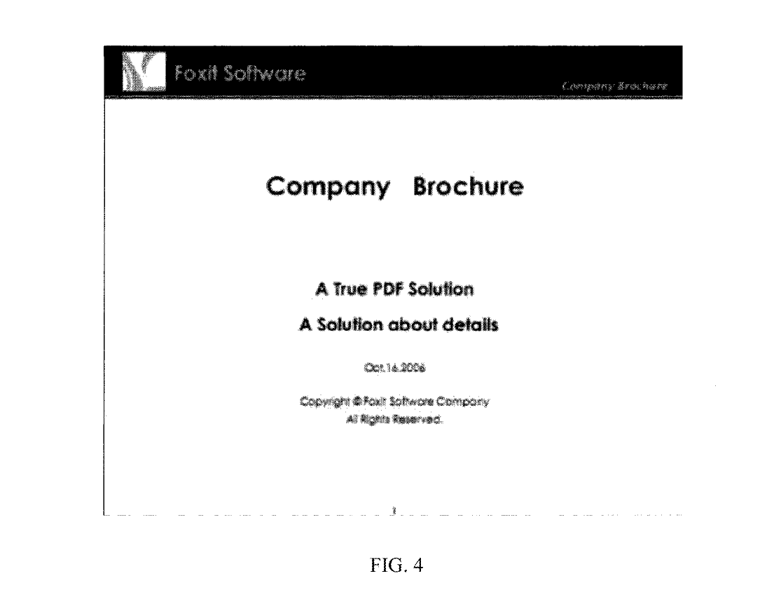

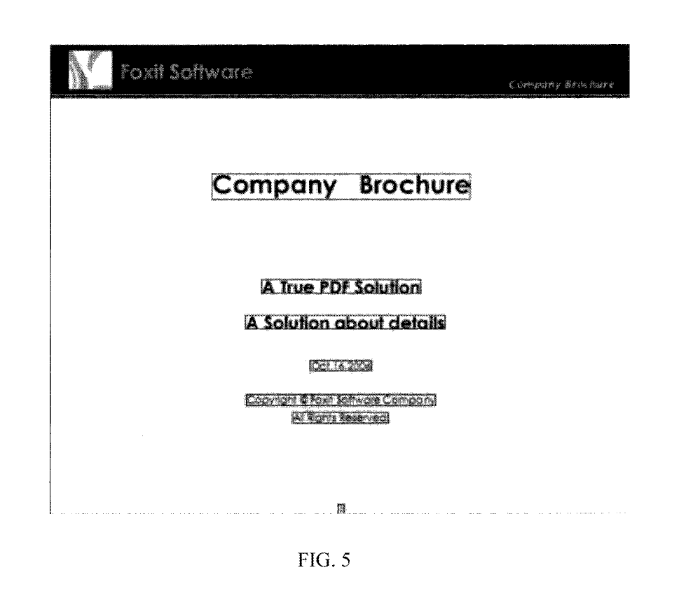

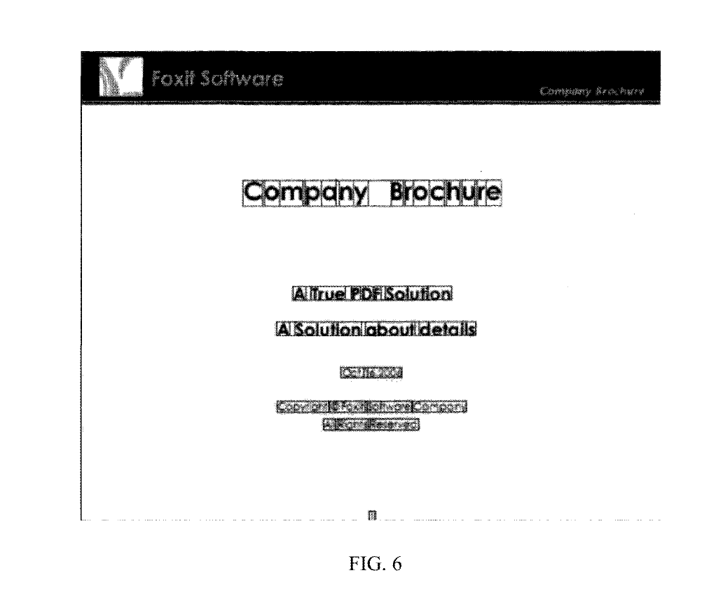

FIG. 3 through FIG. 6 is a schematic diagram of an electronic image file after some operation steps provided by the present invention are performed. Wherein FIG. 3 is a schematic diagram of an electronic image file after rotating by utilizing the present invention. As shown in FIG. 3, the whole electronic image file rotates for a certain angle relative to FIG. 2 in a counterclockwise direction, so that a top image (namely a black-base image marking “Foxit Software”, icons and “Company Brochure”) and underlying texts are in respective straight direction. In FIG. 3, the range indicated by a tag 301 is a white edge part in the range of the left margin of the electronic image file shown in FIG. 3. Similarly, the range indicated by a tag 302 is a white edge part in the range of the right margin of the electronic image file shown in FIG. 3; the range indicated by a tag 303 is a white edge part in the range of the top margin of the electronic image file shown in FIG. 3; the range indicated by a tag 304 is a white edge part in the range of the bottom margin of the electronic image file shown in FIG. 3. Thus, after the white edge parts in the ranges of the top margin, the bottom margin, the left margin and the right margin of the electronic image file are cut off by utilizing the present invention, the schematic diagram shown in FIG. 4 is obtained. On that basis, the non-blank part contained in the electronic image file is segmented in rows to obtain the schematic diagram shown in FIG. 5, and the further segmentation of the step 103 is performed on each row (including a top image) shown in FIG. 5 to obtain FIG. 6. As shown in FIG. 6, the character image can only contain one character, for example, “Company Brochure” can be segmented into fifteen letters and multiple spaces, and of course, the letters and the spaces still exist in the electronic image form. The character images shown in FIG. 6 can further comprise multiple characters, such as words “Solution”, “details” and the like. The top image shown in FIG. 6 still is a character image.

From this, the present invention has the following advantages:

(1) in the present invention, a paper file is scanned to obtain an electronic image file; a non-blank part of the electronic image file is segmented into blocks, thereby obtaining a plurality of blocks; the blocks are segmented into character images; the character images are rearranged to form new blocks according to the position relationship between the character images; the obtained new blocks are arranged to form an electronic file according to the position relationship between the blocks. Therefore, the present invention does not need to perform the processing of character recognition, search on suspicious characters, error correction, association and the like in the existing OCR technology, and only needs to utilize the character images obtained by segmenting the electronic image file to complete a conversion task, thereby greatly improving the conversion efficiency. Simultaneously, the present invention rearranges the character images obtained by segmenting the electronic image file to obtain the electronic file, so that the recognition error is avoided, the content matching degree of the electronic file and the paper file is largely improved, and the character accuracy basically can be up to 100%.

(2) in the present invention, before the electronic image file is segmented, the electronic image file is rotated to enable characrters of the electronic image file to be in a straight direction, thereby facilitating improvement of the accuracy of the segment step;

(3) in the present invention, before the electronic image file is rotated, stains and scratches on the electronic image file are removed, thereby reducing or eliminating influence of noise data, such as the stains, the scratches and the like, on the convertion accuracy of the present invention, saving the conversion time and improving the conversion efficiency;

(4) in the present invention, the white edge part in the ranges of the top margin, the bottom margin, the left margin and the right margin of the electronic image file are cut off, therefore, a page range of the electronic image file can be shortened, the workload of follow-up steps is reduced, and the conversion efficiency and the conversion accuracy are improved.

The above descriptions are merely some exemplary ebodiments of the present invention, but are not intended to limit the present invention. Any modification, equivalent replacement, or improvement made without departing from the principle of the present invention shall fall within the scope of the present invention.

1. A method for converting a paper file into an electronic file, the method comprising:
step 1: scanning a paper file to obtain an electronic image file;
step 2: segmenting a non-blank part contained in the electronic image file into blocks, so that the non-blank part is segmented into a plurality of blocks;wherein the blocks are one of a row or a column;
step 3: segmenting each block into at least one character image;
step 4: determining a position relationship between the blocks and a position relationship between character images belonging to the same block;
step 5: arranging all character images belonging to the same block into a new block according to the position relationship therebetween;
step 6: arranging all the new blocks according to the position relationship between the blocks, thereby obtaining an electronic file.

2. The method according to claim 1, wherein after the step 1 and before the step 2, the method further comprises a step 1-2: rotating the electronic image file to enable characters of the electronic image file in a straight direction.

3. The method according to claim 2, wherein before rotating the electronic image file, the step 1-2 further comprises:removing stains and scratches on the electronic image file.

4. The method according to claim 3, wherein before removing stains and scratches on the electronic image file, the step 1-2 further comprises:enlarging the electronic image file.

5. The method according to claim 2, wherein after rotating the electronic image file to enable characters of the electronic image file in a straight direction, the step 1-2 further comprises:cutting off white edge parts in ranges of a top margin, a bottom margin, a left margin and a right margin of the electronic image file.
